(19) United States
(12) Patent Application Publication
(10) Pub. No.: US 2024/0174356 A1
(43) Pub. Date: May 30, 2024

(54) AIR GUIDANCE DEVICE OF A VERTICAL TAKE-OFF AND LANDING AIRCRAFT, AND VERTICAL TAKE-OFF AND LANDING AIRCRAFT

(71) Applicant: Rolls-Royce Deutschland Ltd & Co KG, Blankenfelde-Mahlow (DE)

(72) Inventors: Antonio BATISTA DE JESUS, München (DE); Andreas REEH, Nürnberg (DE)

(21) Appl. No.: 18/522,211

(22) Filed: Nov. 28, 2023

(30) Foreign Application Priority Data
Nov. 30, 2022 (DE) 10 2022 131 799.4

(51) Int. Cl. B64C 29/00; B64C 7/02; B64C 27/28

(52) U.S. Cl. CPC B64C 29/0091; B64C 7/02; B64C 27/28

(57) ABSTRACT

An air guidance device for a vertical take-off and landing aircraft is provided. A nacelle device with a drive device is connected via a pylon device to a wing of the vertical take-off and landing aircraft and is pivotable by a pivoting device, about an axis of rotation between a first position, such as a propulsion position, and a second position, such as a lift position, relative to the pylon device. A first inlet opening of the air guidance device is arranged on the pylon device in a region in which air conveyed by the drive device in the second position impinges on the pylon device and/or in a region of maximum propeller-generated pressure.

This application claims the benefit of German Patent Application No. 10 2022 131 799.4, filed on Nov. 30, 2022, which is hereby incorporated by reference in its entirety.

### BACKGROUND

The present embodiments relate to an air guidance device of a vertical take-off and landing aircraft, and to a vertical take-off and landing aircraft.

Aircraft that may take off and land vertically (e.g., vertical take-off and landing aircraft (VTOL)) are known in principle. If an electric drive is used as a drive device for such an aircraft, the aircraft is also referred to as an eVTOL aircraft. Such aircraft are of particular interest for the use of aircraft in urban areas (e.g., urban air mobility aircraft (UAM)).

Different designs are used in principle, such as pure rotorcraft or designs with pivotable wings or pivotable drives.

In a design with pivotable drives, these are moved, for example, from a lift position to a propulsion position by a pivotable nacelle device (also known as pods). The nacelle devices are connected to a wing via a pylon device, where the nacelle devices pivot about an axis on the housing of the pylon device.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, improved nacelle devices that, for example, allow efficient flow routing in a lift position are provided.

In this case, a nacelle device is connected to a drive device of the vertical take-off and landing aircraft via a pylon device to a wing of the vertical take-off and landing aircraft. Using a pivoting device, the nacelle device may be pivoted with the drive device about an axis of rotation between a propulsion position and a lift position relative to the pylon device.

A first inlet opening of an air guidance device (e.g., air inlet and air-routing device) is arranged on the pylon device in a region in which air conveyed by the drive device in the lift position impinges on the pylon device. This allows the air conveyed by the drive device to be routed into an interior of the pylon device and also of the drive device via the first inlet opening of the air guidance device (e.g., to have a cooling effect there).

For example, the drive device may thus have a propeller that, in operation, has a rotating surface. The first inlet opening is located in a region of a vertical projection of the rotating surface onto a top side of the pylon device. This is the region of impinging air and/or the region of maximum propeller-generated pressure, which is conveyed downward by the drive device in the lift position and is diverted as required in order to cool components. If this first inlet opening is located at a radial position of a maximum propeller pressure in hovering flight, there is a high pressure difference, which has a positive effect on cooling mass flow.

This provides that the air introduced by the drive device via the first inlet opening may be routed to the drive device as cooling air. In this way, air impinging on the pylon device may cool an electric motor, for example, that drives a propeller of the drive device. The distance between the inlet position and the drive also results in a lower-loss distribution option for the air mass flow to a number of components.

So that the first inlet opening (e.g., in the case of an air-routing device inside a pylon) may also take in air in the propulsion position, in one embodiment, the first inlet opening is at least partially configured as a NACA inflow. These inflows have, among other things, converging side walls.

A further embodiment of the air guidance device has a second inlet opening via which cooling air may be routed to the drive device (e.g., from the underside of the pylon device in the propulsion position). The second inlet opening may also be configured at least partially as a NACA inflow or also as a conventional Pitot inlet.

Since the air guidance device conducts air from the environment into the interior of the pylon device and/or the drive device, dust and other impurities may also enter the interior. Therefore, in one embodiment, at least one filter device for filtering and/or a separating device for separating particles from the air that have been introduced through the first inlet opening and/or the second inlet opening is provided.

For a particularly compact design, the air guidance device is arranged inside the pylon device.

In a further embodiment, an inverter and in each case a part of an inverter is arranged in a non-pivotable region of the pylon device and/or in the pivotable nacelle device. An electric motor is arranged in the pivotable region of the pylon device. Since an inverter requires cooling, the inverter may, in any case, be supplied with the cooling air coming from the air guidance device.

An inverter is arranged in a non-pivotable region of the pylon device, and an electric motor is arranged in the pivotable region of the pylon device. This enables, among other things, the efficient cooling of components (e.g., the use of air-cooled electric motors) without an additional fan and an efficient and low-loss distribution of the cooling air flow to different components (e.g., motor and inverter). Components that have a relatively high pressure loss, such as filters or particle separators, may also be integrated.

In one embodiment, the first inlet opening and/or the second inlet opening may be closed with a controllable door (e.g., in the form of a flap). In the case of straight flight (e.g., cruise), the first inlet opening may be closed, as there is no air conveyed in a vertical direction. The air resistance may be reduced in this case. The inlet opening may also be closed when the aircraft is stationary. Further, when the controllable door is open and the air routing is suitable, the controllable door may also serve as an additional air guidance means to take in cooling air and direct the cooling air to the desired location.

The drive unit and the air-routing device may be coupled via a corresponding seal (e.g., with a pivoting device that is configured as a lever gear, such as with a hydraulically, electrically, or pneumatically driven lever gear). This type of lever gear allows the transmission of greater forces, so that even a heavy nacelle device may be moved and held in position.

The pylon device may also be connected to a non-pivotable drive device, which may provide lift in addition to the pivotable drive device.

### BRIEF DESCRIPTION OF THE DRAWINGS

FIG. 1 shows a partial view of a known aircraft with inlet openings for air;

FIG. 2 shows a schematic view of a vertical take-off and landing aircraft;

FIG. 3 shows a schematic representation of air routing in the vertical take-off and landing aircraft;

FIG. 4 is a schematic representation of the air routing of an embodiment of the vertical take-off and landing aircraft according to FIG. 3;

FIG. 5 is a schematic representation of a further embodiment of the vertical take-off and landing aircraft in A propulsion position with a second inlet opening for air;

FIG. 6 shows a schematic representation of a further embodiment of the vertical take-off and landing aircraft propulsion position with a NACA inlet at a first inlet opening;

FIG. 7 shows a variation of the embodiment according to FIG. 3 with a device for filtering and separating particles from the air;

FIG. 8A shows a detailed illustration of a variation of the embodiment according to FIG. 4 with an inverter in the pivotable nacelle device;

FIG. 8B shows a detailed illustration of a variation of the embodiment according to FIG. 4 with an inverter in the pylon device; and

FIG. 8C is a detailed illustration of a variation of the embodiment according to FIG. 4 with one part of an inverter in the pivotable nacelle device and another part of the inverter in the pylon device.

### DETAILED DESCRIPTION

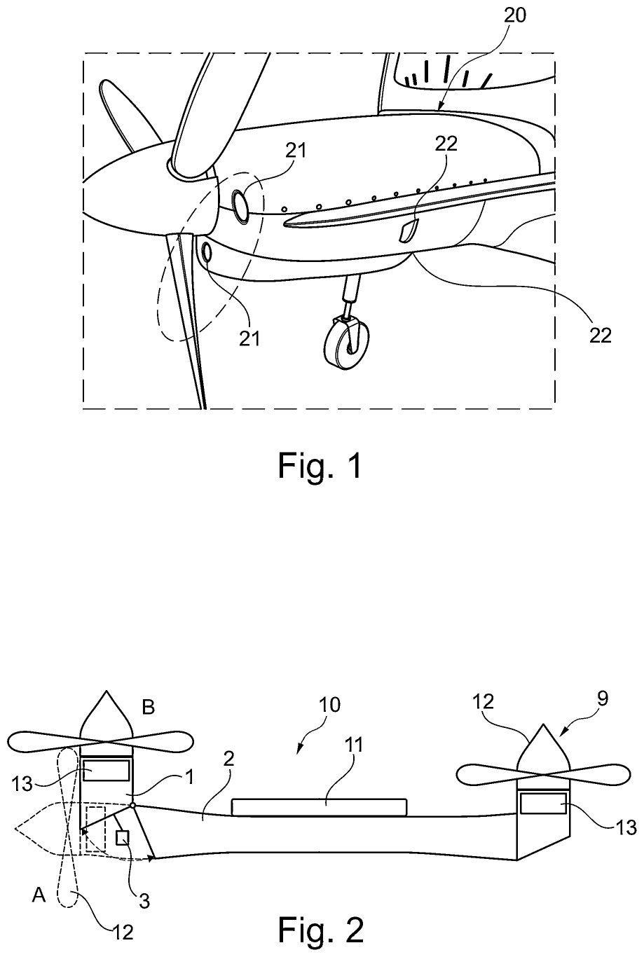

FIG. 1 shows an aircraft 20, known per se, that is driven by a propeller 12. The propeller 12 is configured, for example, such that the propeller 12 is not configured for vertical take-off and landing.

However, FIG. 1 shows that this aircraft 20 has a number of air inlets 21 (e.g., two are visible in FIG. 1) behind a plane of rotation of the propeller 12. This conveys air from the propeller 12 in a direction of the air inlets 21.

A further air inlet in the form of a National Advisory Committee for Aeronautics (NACA) inlet 22, known per se, is arranged on a longitudinal side of the aircraft 20 and receives air flowing along a fuselage of the aircraft 20.

A NACA inlet 22 is a flow-optimized air inlet in an outer skin of vehicles. Inclined side edges, visible in FIG. 1, generate air vortices that displace a slow boundary layer flow. This causes an inward velocity component and induces a mass flow into the NACA inlet 22. Therefore, the NACA inlet 22 may be made small for a given air flow and increases air resistance only slightly.

FIG. 2 shows a vertical take-off and landing aircraft 10 (often also referred to simply as a vertical starter) that has a fundamentally different design as compared to the aircraft 20 according to FIG. 1.

For reasons of clarity, mainly a wing 11 and a pylon device 2 arranged on an underside of the wing 11 are shown in FIG. 2. A passenger cabin, for example, is therefore not shown in FIG. 2. In other embodiments not shown in FIG. 2, the pylon device 2 may also be arranged on an upper side of the wing 11.

The embodiment shown in FIG. 2 is a vertical take-off and landing aircraft 10 in which a drive device 12 (e.g., a rotor or propeller) is pivotably coupled to a nacelle device 1. The rotor is driven by an electric motor 13.

For horizontal flight (e.g., a propulsion position A (shown dashed)), the rotor 12 is oriented at a front side of the pylon device 2, so that the rotor 12 moves air horizontally in a direction of the wing 11 during operation and lift is generated. This is the first position A (e.g., propulsion position) of the drive device 12. In conventional aircraft 20, this is the position in which take-off and landing take place, where extended runways are required in each case.

To enable a vertical take-off and landing aircraft 10 to take off and land vertically, a drive device 12 that may also generate thrust vertically is to be provided. The drive device 12 is arranged, for example, on a nacelle device 1 (also known as a pod) that is configured as a housing that may move relative to the pylon device 2.

In the embodiment shown in FIG. 2 with solid lines, this is achieved by pivoting the drive device 12 into a second position B (e.g., lift position), so that the air conveyed by the rotor 12 generates a downward thrust. The pivoting is performed, for example, upwards relative to the pylon device 2 (e.g., clockwise in this case).

It is possible to switch between the two positions A and B for take-off and landing. This type of pivoting is well known per se.

In the embodiment shown in FIG. 2, the axis of rotation D of the pivoting motion is arranged on the housing of the pylon device 2. The nacelle device 1, and thus the drive device 12, may thus be pivoted relative to the pylon device 2.

For reasons of clarity, a pivoting device 3 that is used to pivot the nacelle device 1 is only shown schematically inside the pylon device 2 in FIG. 2. The pivoting device 3 may be configured as a lever gear, for example.

Further, the illustrated embodiment of the vertical take-off and landing aircraft 10 also has a non-pivotable drive device 9 that is only used for lift. This is also driven by an electric motor 13.

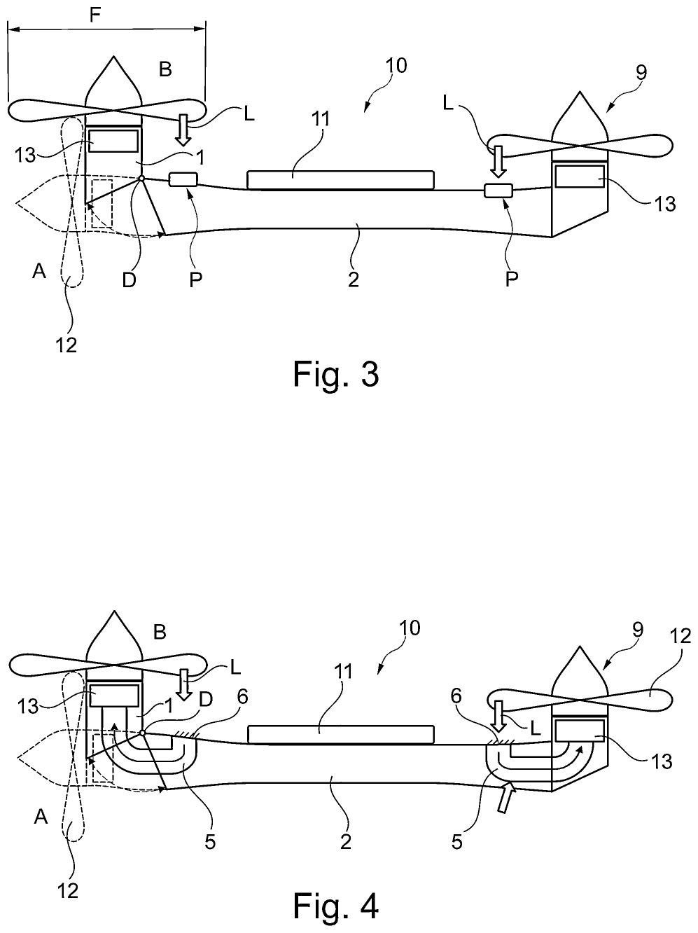

FIG. 3 shows the same configuration as FIG. 2, so that reference may be made to the corresponding description.

The propellers on the pivotable drive device 12 and the non-pivotable drive device 9 each convey a vertical airflow L downwards in the lift position B. This airflow L impinges on an impingement surface P on the pylon device 2. The impingement surface P is to be understood here primarily schematically, since the air L hits the pylon device 2 below a rotating surface F of the propeller, among other things. The conveyed air L primarily impinges on a part of the pylon device 2 that lies in a vertical projection of the rotating surface F onto the upper side of the pylon device 2.

In this region of the pylon device 2, a first inlet opening 6 of an air guidance device 5 is arranged in the embodiment according to FIG. 4, so that the conveyed air L may partially enter through the first inlet opening 6. The conveyed air L is thus conveyed through the air guidance device 5 into the interior of the pylon device 2. Due to the pressure of the conveyed air L at the first inlet opening 6, additional air conveying measures may be dispensed with in many cases. However, it is possible in principle to arrange, for example, fans in the flow path through the air guidance device, although these are not shown in FIG. 4. The first inlet opening 6 may also have a rounded inlet in order to minimize flow losses at the inlet. The first inlet opening 6 may also be configured as a NACA inlet (see FIGS. 1 and 6).

The air conveyed in the air guidance device 5 may be used, for example, to cool an electric motor 13 that drives the propeller. In the embodiment shown in FIG. 4, the electric motor 13 is arranged in the pivotable nacelle device 1. In an alternative embodiment, not shown in FIG. 4, an inverter may be arranged in the non-pivotable part (e.g., the pylon device 2).

A similarly acting device with a first inlet opening 6 and with an adjoining air-routing device 5 is also arranged in a rear region of the pylon device 2, so that the air conveyed by the non-pivotable drive device 9 may also be used as cooling air for the non-pivotable drive device 9.

In the embodiment shown in FIG. 4, an axis of rotation D of the nacelle device 1 is arranged in a wall of the pylon device 2. Alternatively, the axis of rotation D may also be arranged differently. In principle, the nacelle device 1 may be pivoted about the axis of rotation D between a first position (e.g., the propulsion position A) and a second position (e.g., the lift position B) relative to the pylon device 2 by the pivoting device 3. However, the axis of rotation D may be arranged within the pylon device 2 or the nacelle device 1, where the axis of rotation D may lie, for example, on or in an axial center plane of the pylon device 2. By displacing the axis of rotation D into the interior of the pylon device 2, for example, the pivoting of the nacelle device may take place in a spatially compact way. The pivoting device 3 may also be part of the pylon device 2 (e.g., integrated thereinto). This may provide, for example, that parts of the wall of the pylon device are also pivoted. An air-routing device inside the pylon device 2 may be passed through continuously by air in the first position A and in the second position B of the nacelle device 1 (e.g., also in positions in between). For this purpose, the air-routing device may have at least one outlet opening, where the at least one outlet opening has a first outlet region in the side wall of the nacelle device 2 and a second outlet region in an axial end region of the nacelle device 1. The outlet opening may be used, for example, to separate particles that may be discharged due to acceleration by centrifugal forces. The outlet openings may also be used to regulate the air mass flow.

Further, the nacelle device 1 may be configured such that, when coupled to an air guidance device 5 inside the pylon device 2, the nacelle device 1 may always be passed through by air, specifically in the first position A and in the second position B of the nacelle device 1 and also in positions in between. For a particularly efficient design, the interior of the pylon device 2 is at least partially configured as an air guidance device 5. In one embodiment, the nacelle device 1 may have at least one outlet opening, where the at least one outlet opening has a first outlet region in the side wall and a second outlet region in the axial end region of the air guidance device. Air may thus flow out of the nacelle device 1 in different directions (or also flow in, depending on the main flow direction). This arrangement of the outlet region allows air to flow through the nacelle device 1 and the pylon device 2 in any pivoting position of the nacelle device 1.

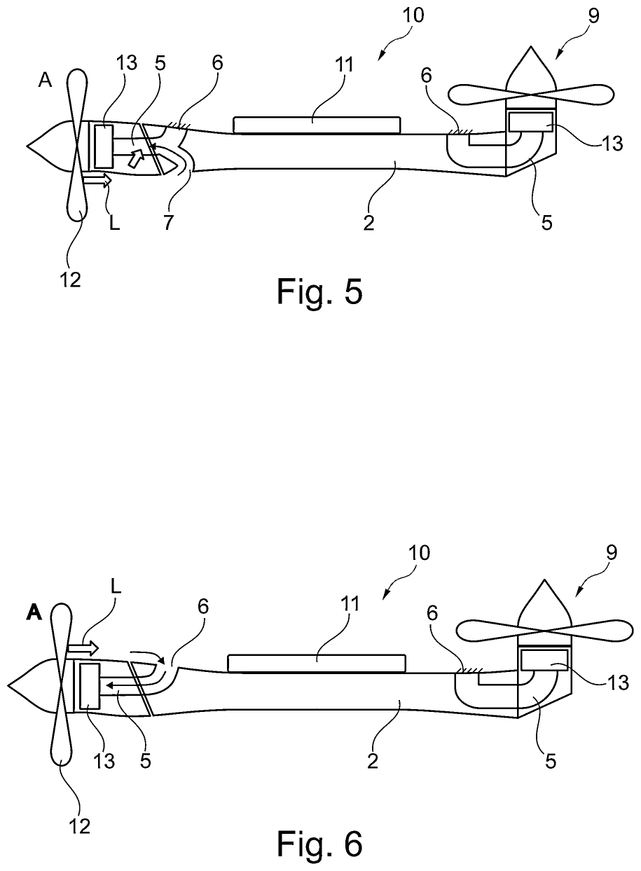

This type of arrangement of the axis of rotation D and/or the design of the nacelle device 1 may also be used in all other embodiments described here (see, for example, FIGS. 5 to 7).

FIG. 5 shows a modification of the embodiment according to FIG. 4, so that reference is made to the corresponding description.

The pivotable drive device 12 is shown in FIG. 5 in the propulsion position B, so that no air L is conveyed from the propeller into the first inlet opening 6. Rather, the air L is conveyed to the rear.

The pylon device 2 has a second inlet opening 7 that is configured as a NACA inlet (see FIG. 1). This allows air flowing past the pylon device 2 to be efficiently channeled into an interior of the air guidance device 5 as cooling air. Depending on pressure conditions in the air guidance device 5, it may be useful in this operating mode to close the path to the first inlet opening 6 in the air guidance device 5 (e.g., by a flap or a valve), so that no cooling air may flow out.

The non-pivotable drive device 9 is configured, for example, without a second inlet opening 7, but may also have one in principle.

FIG. 6 shows a further variation of the embodiment according to FIG. 4, where the pivotable drive device 12 is in the propulsion position B, so that no air L is conveyed from the propeller into the first inlet opening 6. Rather, the air L is conveyed to the rear.

The first inlet opening 6, which receives the vertically downwardly directed airflow L in the lift position A, is provided here with a NACA inlet (see FIG. 1), so that air flowing along the pylon device 2 may be efficiently guided into the interior of the pylon device 2.

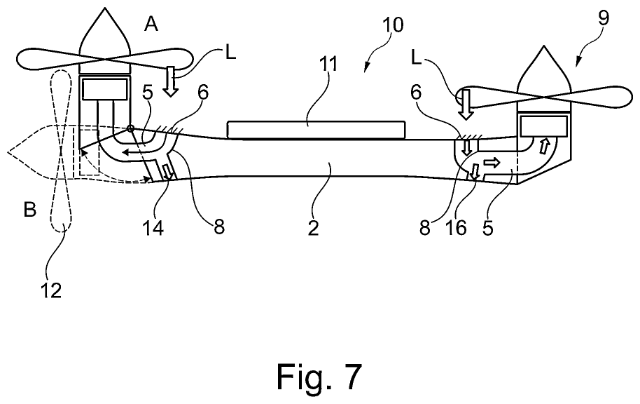

FIG. 7 shows a further embodiment that, in addition to the embodiments according to FIGS. 3 to 6, has a filter device 8 in the air guidance device 5 of the pivotable drive device 12 and the non-pivotable drive device 9, with which particles may be filtered out of the air flowing through the first inlet opening 6. For example, this prevents an accumulation of such particles in the air-cooled electric motor 13 or at least minimizes the accumulation. The filter may also be configured as a separator (e.g., a cyclone).

The collected or separated particles may then be discharged from the pylon device via an outlet opening 14.

The first inlet opening 6 and the second inlet opening 7 are shown as permanently open in FIGS. 3 to 7. In principle, it is possible to provide the inlet openings 6, 7 with a controllable door that may close the inlet openings 6, 7 in straight flight. This reduces the flow resistance when the aircraft is in straight flight.

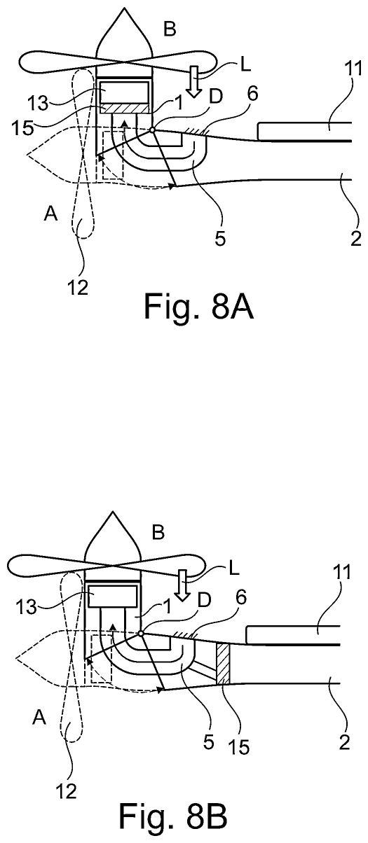

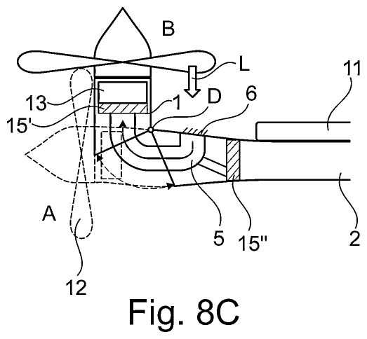

FIGS. 8A to 8C show a variation of the embodiment according to FIG. 4, so that reference may be made to the above description.

In the first variant according to FIG. 8A, the electric motor 13 and an inverter 15 are arranged together in the pivotable nacelle device 1. The cooling air is routed to both components via the air guidance device 5.

However, as shown in FIG. 8B, it is also possible for the inverter 15 to be arranged in the pylon device 2 and coupled to the electric motor 13 in the pivotable nacelle device 1. Cooling air may be routed from the air guidance device 5 to the inverter 15 via a duct.

However, the inverter 15 may also have a number of parts 15′, 15″, of which one part 15′ is arranged in the adjustable nacelle device 1 and the other part 15″ is arranged in the pylon device 2. The inverter 15′, 15″ may then be cooled as described in conjunction with FIGS. 8A and 8B.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. An air guidance device for a vertical take-off and landing aircraft, the air guidance device comprising:
a nacelle device including a drive device,
wherein the nacelle device is connected via a pylon device to a wing of the vertical take-off and landing aircraft and is pivotable by a pivoting device about an axis of rotation between a propulsion position and a lift position relative to the pylon device,
wherein a first inlet opening of the air guidance device is arranged on the pylon device in a region in which air conveyed by the drive device in the lift position impinges on the pylon device, in a region of maximum propeller-generated pressure, or in the region in which air conveyed by the drive device in the lift position impinges on the pylon device and in the region of maximum propeller-generated pressure.

2. The air guidance device of claim 1, wherein the drive device includes a propeller that, in operation, has a rotating surface, and
wherein the first inlet opening is located in a region of vertical projection of the rotating surface onto a top side of the pylon device.

3. The air guidance device of claim 1, wherein air introduced by the drive device via the first inlet opening is routable as cooling air to the drive device.

4. The air guidance device of claim 1, wherein the first inlet opening is formed at least in part as a National Advisory Committee for Aeronautics (NACA) inflow.

5. The air guidance device of claim 1, further comprising a second inlet opening via which cooling air is routable to the drive device.

6. The air guidance device of claim 5, wherein the cooling air is routable to the drive device via the second inlet opening, from an underside of the pylon device in the propulsion position.

7. The air guidance device of claim 5, wherein the second inlet opening is formed at least in part as a National Advisory Committee for Aeronautics (NACA) inflow.

8. The air guidance device of claim 1, further comprising a filter device for filtering, a separating device for separating, or the filter device for filtering and the separating device for separating particles from the air that has been introduced through the first inlet opening, the second inlet opening, or the first inlet opening and the second inlet opening.

9. The air guidance device of claim 1, wherein the air guidance device is arranged inside the pylon device.

10. The air guidance device of claim 1, wherein:
a first inverter is arranged in a non-pivotable region of the pylon device or in the pivotable nacelle device; or
a part of a second inverter is arranged in the non-pivotable region of the pylon device, in the pivotable nacelle device, or in each of the non-pivotable region of the pylon device and in the pivotable nacelle device, respectively, and
wherein an electric motor is arranged in a pivotable region of the pylon device.

11. The air guidance device of claim 1, wherein the first inlet opening, the second inlet opening, or the first inlet opening and the second inlet opening are closable by a controllable door.

12. A vertical take-off and landing aircraft comprising:
a pylon device on a wing, the pylon device comprising an air guidance device,
wherein the air guidance device comprises:
a nacelle device including a drive device,
wherein the nacelle device is connected via a pylon device to a wing of the vertical take-off and landing aircraft and is pivotable by a pivoting device about an axis of rotation between a propulsion position and a lift position relative to the pylon device, and
wherein a first inlet opening of the air guidance device is arranged on the pylon device in a region in which air conveyed by the drive device in the lift position impinges on the pylon device, in a region of maximum propeller-generated pressure, or in the region in which air conveyed by the drive device in the lift position impinges on the pylon device and in the region of maximum propeller-generated pressure.

13. The vertical take-off and landing aircraft of claim 12, wherein the drive device is coupled to a pivoting device that is configured as a lever gear.

14. The vertical take-off and landing aircraft of claim 13, wherein the air guidance device is coupled to the pivoting device.

15. The vertical take-off and landing aircraft of claim 13, wherein the lever gear is a hydraulically, electrically, or pneumatically driven lever gear.

16. The vertical take-off and landing aircraft of claim 12, wherein the pylon device is connected to a non-pivotable drive device.
